(19) United States
(12) Patent Application Publication
(10) Pub. No.: US 2020/0133359 A1
(43) Pub. Date: Apr. 30, 2020

(54) IMAGE FORMING APPARATUS

(71) Applicant: TOSHIBA TEC KABUSHIKI KAISHA, Tokyo (JP)

(72) Inventor: Satoshi HASEGAWA, Kannami Tagata Shizuoka (JP)

(73) Assignee: TOSHIBA TEC KABUSHIKI KAISHA, Tokyo (JP)

(21) Appl. No.: 16/172,469

(22) Filed: Oct. 26, 2018

(51) Int. Cl. G06F 1/26; G06F 1/28; G06F 1/30

(52) U.S. Cl. CPC G06F 1/263; G06F 1/30; G06F 1/28

(57) ABSTRACT

An image forming apparatus includes a power supply key, a latch switch and a processor. The latch switch is connected to a signal line of the power supply key and configured to maintain a state of a power supply in response to pressing on the power supply key when the latch switch is in an ON state. The processor is configured to perform control to set the state of the latch switch to an OFF state in a first mode corresponding to a state in which the image forming apparatus is not connected with an external device, and to set the state of the latch switch to the ON state in a second mode corresponding to a state in which the image forming apparatus is connected with the external device.

### FIELD

Embodiments described herein relate generally to an image forming apparatus.

### BACKGROUND

A conventional image forming apparatus may be provided with a power supply key on an operation panel instead of a power supply switch for directly turning off an AC (Alternating Current) power supply. Such an image forming apparatus has an OFF mode which turns on a minimum power supply for detecting pressing on the power supply key. The image forming apparatus turns on a power supply of the entire apparatus in response to the pressing on the power supply key in a standby state in the OFF mode.

In recent years, the image forming apparatus may have various operation modes in addition to the OFF mode in order to suppress power consumption. For example, the image forming apparatus has a function of automatically shifting to a power saving mode for the purpose of energy saving when there is no printing request. For example, the image forming apparatus also has a function of automatically shifting to a standby mode in which the image forming apparatus can be started in response to an external printing request such as a facsimile or a network printing when there is no printing request. In some cases, the image forming apparatus has a function of automatically shifting to the above-mentioned OFF mode instead of the power saving mode when the image forming apparatus is not in a state in which it can be started from the outside, such as when the image forming apparatus is not connected with a cable. This is to minimize the power consumption of the image forming apparatus.

However, for example, the AC power supply is temporarily turned off due to a power failure or the like while the image forming apparatus is on standby in the standby mode, and after the power failure is eliminated, the AC power supply is turned on again. In such a case, unless a user presses the power supply key, the image forming apparatus remains in the OFF mode. In other words, unless the user presses the power supply key, the image forming apparatus no longer recovers to the standby mode again. Therefore, if the user does not notice that he/she needs to press the power supply key, the image forming apparatus keeps in a state in which the facsimile or the network printing cannot be received.

### DESCRIPTION OF THE DRAWINGS

FIG. 1 is a block diagram illustrating a hardware configuration of an image forming apparatus according to at least one embodiment;

FIG. 2 is a diagram illustrating a circuit configuration of the image forming apparatus according to at least one embodiment;

FIG. 3 is a flowchart depicting a mode transition processing when an AC power supply in the image forming apparatus is plugged in according to at least one embodiment;

FIG. 4 is a flowchart depicting a power failure recovery processing while the image forming apparatus is on standby in a standby mode according to at least one embodiment; and

FIG. 5 is a flowchart depicting the power failure recovery processing while the image forming apparatus is on standby in an OFF mode according to at least one embodiment.

### DETAILED DESCRIPTION

In accordance with at least one embodiment, an image forming apparatus comprises a power supply key; a latch switch connected to a signal line of the power supply key and configured to maintain a state of a power supply in response to pressing on the power supply key when the latch switch is in an ON state; and a processor configured to perform control to set the state of the latch switch to an OFF state in a first mode, the first mode corresponding to a state in which the image forming apparatus is not connected with an external device, and to set the state of the latch switch to the ON state in a second mode, the second mode corresponding to a state in which the image forming apparatus is connected with the external device.

Hereinafter, at least one embodiment is described with reference to the accompanying drawings.

The arrangement of an image forming apparatus 1 is described first.

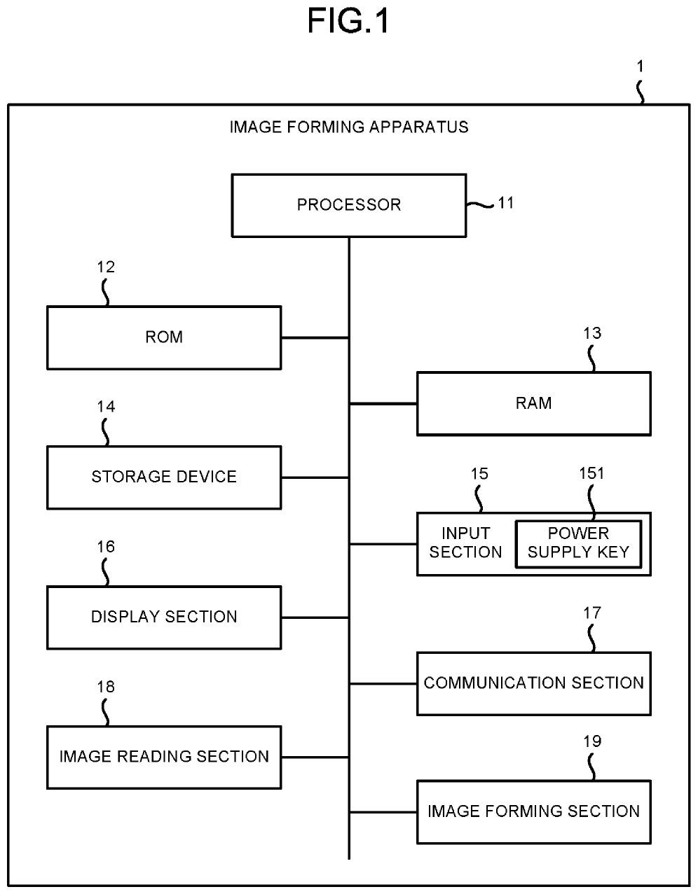

FIG. 1 is a block diagram illustrating a hardware configuration of the image forming apparatus 1. The image forming apparatus 1 executes a printing processing, a scanning processing, a fax processing, and the like. For example, the image forming apparatus 1 is an MFP (Multi-Function Peripheral). The image forming apparatus 1 includes a processor 11, a ROM (Read Only Memory) 12, a RAM (Random Access Memory) 13, a storage device 14, an input section 15, a display section 16, a communication section 17, an image reading section 18 and an image forming section 19.

The processor 11 executes various processing. For example, the processor 11 is a CPU (Central Processing Unit). The processor 11 executes various processing by executing programs stored in the ROM 12 or the storage device 14.

The ROM 12 stores programs for the processor 11 to execute various processing, control data, or the like. The ROM 12 is an example of a storage section. The RAM 13 is a working memory.

The storage device 14 may be a rewritable nonvolatile memory. For example, the storage device 14 may be a SSD (Solid State Drive), a HDD (Hard Disk Drive), or the like. The storage device 14 stores programs for the processor 11 to execute various processing, control data and the like. Further, the storage device 14 stores data collected through various processing by the processor 11 and the like.

The input section 15 receives an input by a user. For example, the input section 15 is a touch pad stacked on a keyboard or the display section 16 described later. The input section 15 includes a power supply key 151. The power supply key 151 is used for starting the entire image forming apparatus 1. The power supply key 151 receives pressing by the user. The circuit arrangement of the image forming apparatus 1 including the power supply key 151 is described later.

The display section 16 displays various information. For example, the display section 16 is a liquid crystal display.

The communication section 17 includes an interface for the image forming apparatus 1 to transmit and receive data to and from other devices via a network. The communication section 17 includes an interface for facsimile communication. The communication section 17 may include a wired communication interface or a wireless communication interface.

The image reading section 18 is a scanner that reads a document to acquire image data from the document. For example, the image reading section 18 includes an image sensor and the like. The image sensor is an image capturing element in which pixels for converting light into electrical signals (image signals) are arranged in a line. The image sensor may be, for example, a CCD (Charge Coupled Device), a CMOS (Complementary Metal Oxide Semiconductor), or other image capturing elements.

The image forming section 19 is a printer for forming an image on a printing medium. For example, the image forming section 19 includes a photoconductive drum, an electrostatic charger, an exposure device and a developing device. A surface of the photoconductive drum is uniformly charged by the electrostatic charger. The exposure device emits light having a wavelength capable of forming a latent image on the charged photoconductive drum according to electric signals of the document data or the image data to form an electrostatic latent image on the charged photoconductive drum. The developing device attaches toner (developer) to the electrostatic latent image formed on the photoconductive drum to form a toner image on the surface of the photoconductive drum. The image forming section 19 transfers the toner image formed on the surface of the photoconductive drum onto the printing medium and fixes the toner image on the printing medium, thereby forming an image on the printing medium.

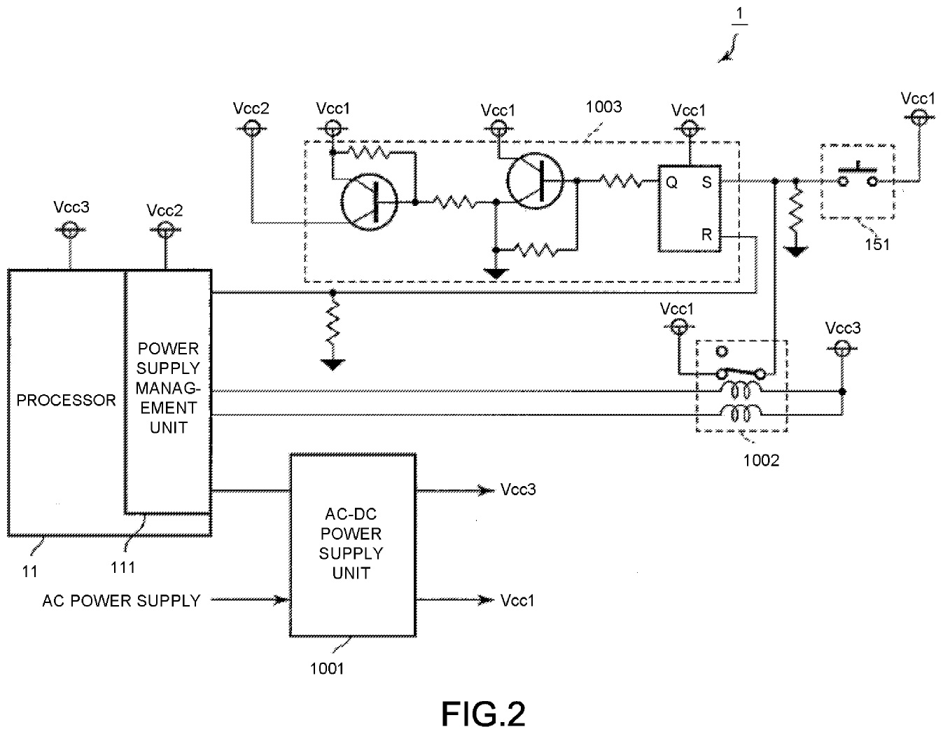

FIG. 2 is a diagram illustrating a circuit arrangement of the image forming apparatus 1. The image forming apparatus 1 operates in various operation modes as exemplified below by the circuit configuration shown in FIG. 2.

First, operation modes of the image forming apparatus 1 and the power supplied (output) to the image forming apparatus 1 in each operation mode are described. The operation modes include an OFF mode, a standby mode, and a normal mode. The electric power supplied in the image forming apparatus 1 sequentially increases in order in the OFF mode, the standby mode, and the normal mode.

The OFF mode is described. The OFF mode is an operation mode in which a minimal DC (Direct Current) power for enabling the detection of pressing on the power supply key 151 is supplied to the image forming apparatus 1. The image forming apparatus 1 cannot communicate with an external device via the communication section 17 in standby state in the OFF mode. In standby state in the OFF mode, the image forming apparatus 1 cannot be started in response to a signal from the external device via the communication section 17. In other words, the image forming apparatus 1 is not connected with the external device in the standby state in the OFF mode. Therefore, the OFF mode relates to a state in which the image forming apparatus 1 is not connected with the external device. The image forming apparatus 1 turns on only a DC power supply Vcc 1 in the standby state in the OFF mode. Vcc 1 is a DC power supply for supplying minimum power to the inside of the image forming apparatus 1 if the AC power supply in the image forming apparatus 1 is plugged in to enable the detection of pressing on the power supply key 151. Vcc 1 relates to the OFF mode. Therefore, the OFF mode is also referred to as an operation mode in which Vcc 1 is rising. It can be said that the OFF mode relates to Vcc 1. The OFF mode is also referred to as a first mode. Vcc 1 is also referred to as a first power supply.

The standby mode is described. The standby mode is an operation mode in which the minimum power for the image forming apparatus 1 to communicate with the external device via the communication section 17 is supplied to the inside of the image forming apparatus 1. For example, the communication with the external device refers to reception of a signal including a printing request from the external device, such as facsimile or network printing. The image forming apparatus 1 can communicate with the external device via the communication section 17 in the standby state in the standby mode. In the standby state in the standby mode, the image forming apparatus 1 can be started in response to the signal from the external device via the communication section 17. In other words, the image forming apparatus 1 is connected with the external device in the standby state in the standby mode. Therefore, the standby mode relates to a state in which the image forming apparatus 1 is connected with the external device. The image forming apparatus 1 turns on DC power supplies Vcc 1 and Vcc 2 in the standby state in the standby mode. Vcc 2 is higher in power than Vcc 1. Vcc relates to the standby mode. It can be said that the standby mode is an operation mode in which Vcc 1 and Vcc 2 are rising. For example, the image forming apparatus 1 raises Vcc 2 in addition to Vcc 1 in accordance with the transition from the OFF mode to the standby mode. The standby mode is also referred to as a second mode. Vcc 2 is also referred to as a second power supply.

The normal mode is described. The normal mode is an operation mode in which power for starting the entire image forming apparatus 1 is supplied to the inside of the image forming apparatus 1. The image forming apparatus 1 turns on Vcc 1, Vcc 2 and Vcc 3 in the standby state in the normal mode. Vcc 3 is higher in the power than Vcc 2. Vcc 3 relates to the normal mode. Vcc 3 relates to the start of the processor 11. The normal mode is an operation mode in which Vcc 1, Vcc 2 and Vcc 3 are rising. For example, the operation mode of the image forming apparatus 1 shifts from the OFF mode to the normal mode via the standby mode in response to pressing on the power supply key 151 in the standby state in the OFF mode. The image forming apparatus 1 raises Vcc 3 in addition to Vcc 1 and Vcc 2 in accordance with the transition from the OFF mode to the normal mode through the standby mode. For example, the operation mode of the image forming apparatus 1 shifts from the standby mode to the normal mode in response to communication with the external device (e.g., reception of a printing request) in the standby state in the standby mode. The image forming apparatus 1 raises Vcc 3 in addition to Vcc 1 and Vcc 2 in accordance with the transition from the standby mode to the normal mode. The normal mode is also referred to as a third mode. Vcc 3 is also referred to as a third power supply.

Next, the circuit configuration of the image forming apparatus 1 is described. The image forming apparatus 1 includes an AC-DC (Alternating Current-Direct Current) power supply unit 1001, a latch switch 1002, and a circuit 1003 in addition to the above-described processor 11 and power supply key 151.

The power supply key 151 is described. The power supply key 151 is connected to a signal line of the circuit 1003. Through the power supply key 151, Vcc 1 is turned on in any operation mode. Depending on whether the user presses the power supply key 151, the state of supplying the power from Vcc 1 to the circuit 1003 is switched. In response to the pressing on the power supply key 151 by the user, the power from Vcc 1 is supplied to the circuit 1003. The power supplied from Vcc 1 to the circuit 1003 through the power supply key 151 is also referred to as a power supply key signal. In a state in which the user does not press the power supply key 151, the supply of the power from Vcc 1 to the circuit 1003 is cut off.

The AC-DC power supply unit 1001 is described. The AC-DC power supply unit 1001 converts an AC power supply into a DC power supply. The AC-DC power supply unit 1001 supplies the power from Vcc 1 to the inside of the image forming apparatus 1 based on supply of the AC power by the plug-in. Furthermore, the AC-DC power supply unit 1001 supplies the power from Vcc 3 to the inside of the image forming apparatus 1 in response to a signal from the power supply management unit 111 described later.

The latch switch 1002 is described. The latch switch 1002 is connected to a signal line of the power supply key 151. The latch switch 1002 is connected to the signal line of the circuit 1003. The latch switch 1002 is capable of holding contacts. The latch switch 1002 holds the contact even when the AC power supply is turned off (disconnected). For example, the latch switch 1002 may be a latching relay or a ratchet relay, but is not limited thereto. The latch switch 1002 is switched to the ON or OFF state by the processor 11 in the normal mode. The ON state is a state in which it is connected to Vcc 1. The OFF state is a state in which it is not connected to any DC power supply such as Vcc 1. In other words, the latch switch 1002 maintains the state of the power supply based on the pressing on the power supply key 151 in the ON state. The state of the power supply based on the pressing on the power supply key 151 is a state of supplying the power from Vcc 1 to the circuit 1003. The power supplied from Vcc 1 to the circuit 1003 through the latch switch 1002 is also referred to as a power supply key signal. On the other hand, the latch switch 1002 does not supply the power from Vcc 1 to the circuit 1003 in the OFF state.

The circuit 1003 is described. The circuit 1003 is connected to the signal line of the power supply key 151. The circuit 1003 is connected to the signal line of the latch switch 1002. The power from Vcc 1 is supplied to the circuit 1003 in response to pressing on the power supply key 151 or the ON state of the latch switch 1002. The circuit 1003 raises Vcc 2 based on the supply of the power from Vcc 1. For example, the circuit 1003 is a flip-flop, a transistor, and the like. The configuration of the circuit 1003 is not limited as long as the circuit 1003 is configured to raise Vcc 2 based on the supply of the power from Vcc 1. The circuit 1003 is also referred to as a first circuit.

The processor 11 is described. The processor 11 includes a power supply management unit 111. The power supply management unit 111 operates based on the supply of the power from Vcc 2. In other words, the power supply management unit 111 operates in the standby mode and the normal mode, but does not operate in the OFF mode. The power supply management unit 111 raises Vcc 3 based on the supply of the power from Vcc 2. For example, the power supply management unit 111 outputs a signal for instructing the AC-DC power supply unit 1001 to raise Vcc 3 using the AC-DC power supply unit 1001. The power supply management unit 111 is also referred to as a second circuit. The power supply management unit 111 may not be contained in the processor 11 as long as it can raise Vcc 3 based on the supply of the power from Vcc 2.

Furthermore, the processor 11 is started based on the supply of the power from Vcc 3 to operate. In other words, the processor 11 operates in the normal mode except for the power supply management unit 111, and does not operate in either the OFF mode or the standby mode. The processor 11 controls the state of the latch switch 1002 in the standby state in the normal mode. For example, the processor 11 performs control to set the state of the latch switch 1002 in the OFF mode to an OFF state. As a result, even when the operation mode of the image forming apparatus 1 shifts from the normal mode to the OFF mode, the latch switch 1002 maintains the OFF state in the OFF mode. On the other hand, for example, the processor 11 performs control to set the state of the latch switch 1002 in the standby mode to the ON state. Thereby, even when the operation mode of the image forming apparatus 1 shifts from the normal mode to the standby mode, the latch switch 1002 maintains the ON state in the standby mode.

Next, the processing by the image forming apparatus 1 is described.

A mode transition processing at the time the AC power supply is plugged in is described.

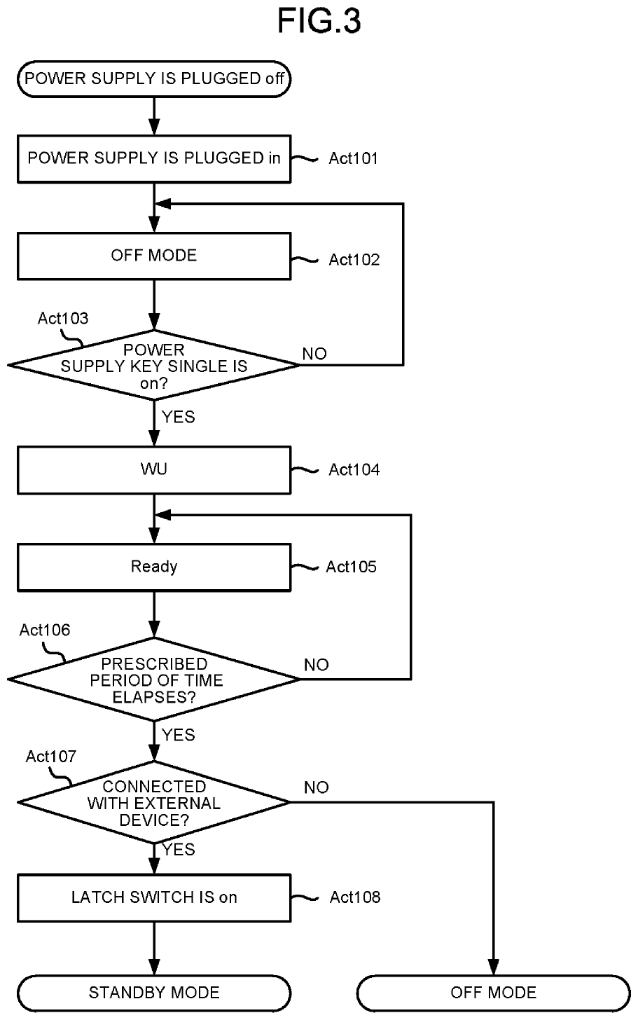

FIG. 3 is a flowchart depicting the mode transition processing at the time the AC power supply in the image forming apparatus 1 is plugged in. Changes such as replacing processing order, deleting a part of processing and the like may be made as appropriate. Here, in the image forming apparatus 1, the plug of the AC power is OFF (disconnected). It is assumed that the state of the latch switch 1002 is in the OFF state.

The image forming apparatus 1 receives supply of the power from the AC power supply in response to plug-in (connection) of the AC power supply (Act 101). The image forming apparatus 1 operates in the OFF mode (Act 102). In Act 102, the AC-DC power supply unit 1001 supplies the power from Vcc 1 to the inside of the image forming apparatus 1 based on the supply of the power from the AC power supply by the plug-in. At this time point, in the image forming apparatus 1, Vcc 1 is rising. Thus, the image forming apparatus 1 operates in the OFF mode.

The image forming apparatus 1 receives the power supply key signal based on pressing on the power supply key 151 (Act 103). If the power supply key 151 is not pressed (No in Act 103), the image forming apparatus 1 stands by in the OFF mode until the power supply key 151 is pressed. If the power supply key 151 is pressed (Yes in Act 103), the image forming apparatus 1 is started and warms up (Act 104). In Act 104, the power from Vcc 1 is supplied to the circuit 1003 based on pressing on the power supply key 151 by the user. The circuit 1003 raises Vcc 2 based on the supply of the power from Vcc 1. At this time point, in the image forming apparatus 1, Vcc 1 and Vcc 2 are rising. As a result, the operation mode of the image forming apparatus 1 shifts from the OFF mode to the standby mode. The power supply management unit 111 operates based on the supply of the power from Vcc 2 and raises Vcc 3 based on the supply of the power from Vcc 2. The processor 11 is started based on the supply of the power from Vcc 3. At this time point, in the image forming apparatus 1, Vcc 1, Vcc 2 and Vcc 3 are rising. As a result, the operation mode of the image forming apparatus 1 shifts from the standby mode to the normal mode.

The image forming apparatus 1 stands by in a ready state in which the printing is enabled (Act 105). The image forming apparatus 1 determines whether or not a prescribed period of time elapses (Act 106). In Act 106, the processor 11 determines whether or not the duration of the ready state reaches a prescribed period of time. The prescribed period of time refers to a waiting time for shifting from the normal mode to either the standby mode or the OFF mode for power saving. The length of the prescribed period of time can be arbitrarily set. If the duration of the ready state does not reach the prescribed period of time (No in Act 106), the image forming apparatus 1 stands by in the ready state until the duration of the ready state reaches the prescribed period of time.

If the duration of the ready state reaches the prescribed period of time (Yes in Act 106), the image forming apparatus 1 determines whether it is connected with or not connected with the external device (Act 107). In Act 107, for example, the processor 11 determines whether or not it is connected with the external device as described below. If the image forming apparatus 1 can be started in response to the signal from the external device via the communication section 17, the processor 11 determines that it is connected with the external device. For example, if a cable for connecting the external device to the communication section 17 is connected, the processor 11 may determine that it is connected with the external device. If the processor 11 can recognize the connection with the external device through wireless communication via the communication section 17, the processor 11 may determine that it is connected with the external device. On the other hand, if the image forming apparatus 1 cannot be started in response to the signal from the external device via the communication section 17, the processor 11 determines that it is not connected with the external device. For example, if no cable for connecting the external device to the communication section 17 is connected, the processor 11 may determine that it is not connected with the external device. If the processor 11 cannot recognize the connection with the external device through the wireless communication via the communication section 17, the processor 11 may determine that it is not connected with the external device.

If the image forming apparatus 1 is not connected with the external device (No in Act 107), the image forming apparatus 1 performs control to operate in the OFF mode. In this case, the processor 11 performs control to switch the operation mode from the normal mode to the OFF mode. The processor 11 performs control to maintain the latch switch 1002 in the OFF state and to lower (turn off) Vcc 2 and Vcc 3 according to the determination result indicating that it is not connected with the external device. For example, the processor 11 outputs a signal for lowering Vcc 2 to the flip-flop of the circuit 1003. The circuit 1003 lowers Vcc 2 based on the signal from the processor 11. As a result, the power supply management unit 111 does not operate because it is not supplied with the power from Vcc 2. Furthermore, the processor 11 outputs a signal for lowering Vcc 3 to the AC-DC power supply unit 1001. The AC-DC power supply unit 1001 lowers Vcc 3 based on the signal from the processor 11. As a result, the processor 11 does not operate because it is not supplied with the power from Vcc 3. At this time point, in the image forming apparatus 1, only Vcc 1 is rising. Thus, the image forming apparatus 1 operates in the OFF mode.

If the image forming apparatus 1 is connected with the external device (Yes in Act 107), the image forming apparatus 1 sets the state of the latch switch 1002 to the ON state (Act 108). In Act 108, the processor 11 performs control to switch the latch switch 1002 from the OFF state to the ON state according to the determination result indicating that it is connected with the external device. Next, the image forming apparatus 1 performs control to operate in the standby mode. Here, the processor 11 performs control to switch the operation mode from the normal mode to the standby mode. The processor 11 performs control to lower Vcc 3 according to the determination result indicating that it is not connected with the external device. For example, the processor 11 outputs a signal for lowering Vcc 3 to the AC-DC power supply unit 1001. The AC-DC power supply unit 1001 lowers Vcc 3 based on the signal from the processor 11. As a result, the processor 11 does not operate because it is not supplied with the power from Vcc 3. At this time point, in the image forming apparatus 1, Vcc 1 and Vcc 2 are rising. Since Vcc 2 is rising, the power supply management unit 111 can operate. As a result, the operation mode of the image forming apparatus 1 becomes the standby mode.

Next, a power failure recovery processing in the standby state in the standby mode is described.

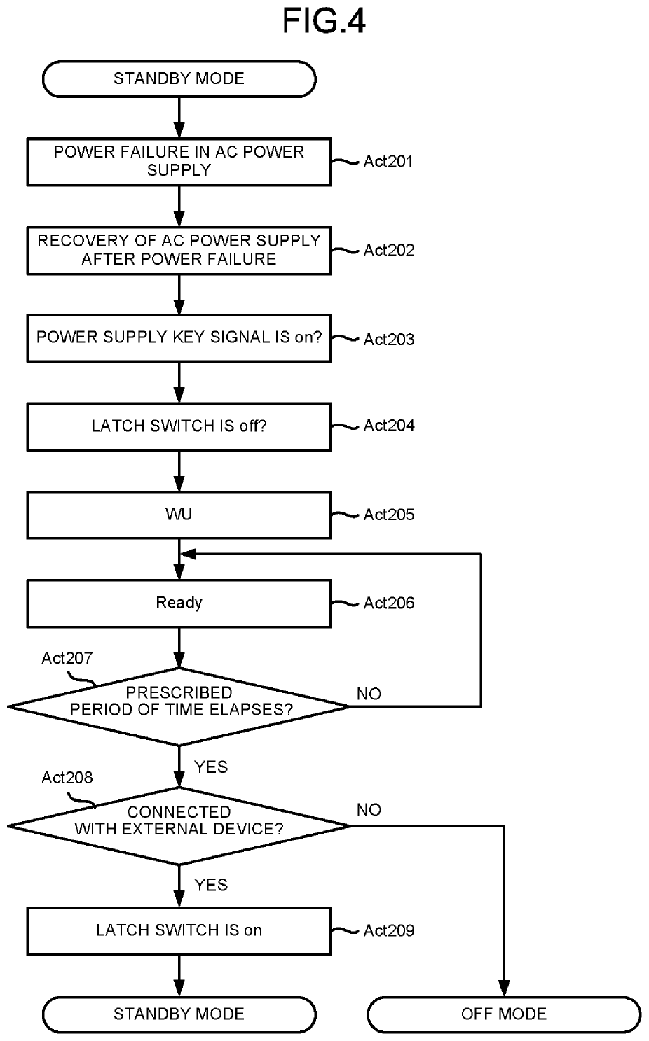

FIG. 4 is a flowchart depicting the power failure recovery processing in the standby state in the standby mode in the image forming apparatus 1. Changes such as replacing processing order, deleting a part of processing, and the like may be made as appropriate. Here, while the image forming apparatus 1 is in the standby state in the standby mode, the state of the latch switch 1002 is the ON state. The processor 11 can switch the operation mode to either the OFF mode or the standby mode based on the startup in response to recovery of the AC power supply after the AC power supply is turned off, as described below.

In the image forming apparatus 1, the AC power supply is turned off due to the power failure or the like (Act 201). In Act 201, Vcc 1 and Vcc 2 are lowered due to the shutdown of the AC power supply. The image forming apparatus 1 is supplied with power from the AC power supply in response to recovery of the AC power supply after the AC power supply is turned off (Act 202). In Act 202, the AC-DC power supply unit 1001 supplies the power from Vcc 1 to the inside of the image forming apparatus 1 based on supply of the power from the AC power supply. At this time point, in the image forming apparatus 1, Vcc 1 is rising.

The image forming apparatus 1 receives the power supply key signal (Act 203). In Act 203, since the latch switch 1002 is in the ON state, the latch switch 1002 supplies the power from Vcc 1 to the circuit 1003. In other words, the circuit 1003 receives the power supply key signal from the latch switch 1002. The circuit 1003 raises Vcc 2 based on the supply of Vcc 1. In other words, the circuit 1003 raises Vcc 2 based on the supply of the power from Vcc 1 in response to the ON state of the latch switch 1002 according to the recovery of the AC power supply after the AC power supply is turned off. At this time point, in the image forming apparatus 1, Vcc 1 and Vcc 2 are rising. Next, the power supply management unit 111 raises Vcc 3 based on the supply of the power from Vcc 2. At this time point, in the image forming apparatus 1, Vcc 1, Vcc 2 and Vcc 3 are rising. Next, the processor 11 is started based on the supply of the power from Vcc 3. As a result, the operation mode of the image forming apparatus 1 shifts from the OFF mode to the normal mode via the standby mode without pressing the power supply key 151 by the user.

The image forming apparatus 1 performs control to switch the latch switch 1002 from the ON state to the OFF state (Act 204). In Act 204, the processor 11 performs control to switch the latch switch 1002 from the ON state to the OFF state based on startup according to recovery of the AC power supply after the AC power supply is turned off.

The image forming apparatus 1 warms up (Act 205). The image forming apparatus 1 stands by in the ready state in which the printing is enabled (Act 206). The image forming apparatus 1 determines whether or not the prescribed period of time elapses (Act 207). In Act 207, the image forming apparatus 1 performs the same processing as in Act 106 described above. If the duration of the ready state does not reach the prescribed period of time (No in Act 207), the image forming apparatus 1 stands by in the ready state until the duration of the ready state reaches the prescribed period of time.

If the duration of the ready state reaches the prescribed period of time (Yes in Act 207), the image forming apparatus 1 determines whether it is connected with or not connected with the external device (Act 208). In Act 208, the processor 11 performs the same processing as in Act 107 described above.

If the image forming apparatus 1 is not connected with the external device (No in Act 208), the image forming apparatus 1 performs control to operate in the OFF mode. In this case, the processor 11 performs control to shift the operation mode from the normal mode to the OFF mode. The processor 11 performs control to maintain the latch switch 1002 in the OFF state and lower Vcc 2 and Vcc 3 according to the determination result indicating that the image forming apparatus 1 is not connected with the external device. With reference to FIG. 3, as described above, the processor 11 may perform control to lower Vcc 2 and Vcc 3. The power supply management unit 111 does not operate because it is not supplied with the power from Vcc 2. The processor 11 does not operate because it is not supplied with the power from Vcc 3. At this time point, in the image forming apparatus 1, only Vcc 1 is rising. Thus, the image forming apparatus 1 operates in the OFF mode.

If the image forming apparatus 1 is connected with the external device (Yes in Act 208), the image forming apparatus 1 sets the state of the latch switch 1002 to the ON state (Act 209). In Act 209, the processor 11 performs control to switch the state of the latch switch 1002 from the OFF state to the ON state according to the determination result indicating that the image forming apparatus 1 is connected with the external device. Next, the image forming apparatus 1 performs control to operate in the standby mode. Here, the processor 11 performs control to switch the operation mode from the normal mode to the standby mode. The processor 11 performs control to lower Vcc 3 according to the determination result indicating that the image forming apparatus 1 is connected with the external device. With reference to FIG. 3, as described above, the processor 11 may perform control to lower Vcc 3. The processor 11 does not operate because it is not supplied with the power from Vcc 3. At this time point, in the image forming apparatus 1, Vcc 1 and Vcc 2 are rising. Since Vcc 2 is rising, the power supply management unit 111 can operate. As a result, the image forming apparatus 1 operates in the standby mode. As described above, the image forming apparatus 1 maintains the standby mode without operation by the user after recovery of the AC power supply even if the AC power supply is turned off in the standby state in the standby mode.

The power failure recovery processing in the standby state in the OFF mode is described below.

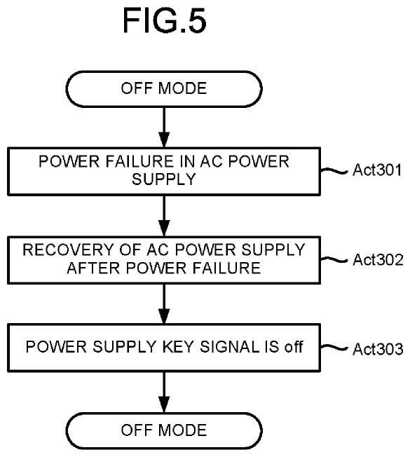

FIG. 5 is a flowchart depicting the power failure recovery processing in the standby state in the OFF mode in the image forming apparatus 1. Changes such as replacing processing order, deleting a part of processing and the like may be made as appropriate. Here, while the image forming apparatus 1 is on standby in the OFF mode, the state of the latch switch 1002 is the OFF state. The processor 11 can maintain the operation mode in the OFF mode based on the startup in response to the recovery of the AC power supply after the AC power supply is turned off, as described below.

The image forming apparatus 1 enters a state in which the AC power supply is turned off due to a power failure or the like (Act 301). In Act 301, Vcc 1 is lowered since the AC power supply is turned off. The image forming apparatus receives supply of power from the AC power supply in response to the recovery of the AC power supply after the AC power supply is turned off (Act 302). In Act 302, the AC-DC power supply unit 1001 supplies the power from Vcc 1 to the inside of the image forming apparatus 1 based on the supply of power from the AC power supply. At this time point, in the image forming apparatus 1, Vcc 1 is rising.

The image forming apparatus 1 stands by without receiving the power supply key signal (Act 303). In Act 303, since the latch switch 1002 is in the OFF state, the latch switch 1002 does not supply the power from Vcc 1 to the circuit 1003. Therefore, the circuit 1003 does not raise Vcc 2. In this manner, the image forming apparatus 1 maintains the OFF mode without operation by the user after the recovery of the AC power supply even if the AC power supply is turned off in the standby state in the OFF mode.

According to some embodiments, the image forming apparatus 1 performs control to set the state of the latch switch 1002 in the OFF mode to the OFF state, and sets the state of the latch switch 1002 in the standby mode to the ON state. As a result, the image forming apparatus 1 maintains the power state based on the pressing on the power supply key 151 without pressing the power supply key 151 even when the AC power supply recovers after the AC power supply is turned off in the standby state in the standby mode. The image forming apparatus 1 can avoid situations such as staying in the OFF mode in which the facsimile cannot be received when recovering after the AC power supply is turned off in the standby state in the standby mode. Furthermore, when the image forming apparatus 1 recovers after the AC power supply is turned off, the user does not need to press the power supply key 151 again in order to switch the operation mode of the image forming apparatus 1 to the standby mode.

According to some embodiments, the image forming apparatus 1 includes the circuit 1003 for raising Vcc 2 based on the supply of the power from Vcc 1 in response to the ON state of the latch switch, and the power supply management unit 111 for raising Vcc 3 based on the supply of the power from Vcc 2. Thereby, the operation mode of the image forming apparatus 1 automatically shifts from the OFF mode to the normal mode through the standby mode without the operation of the processor 11. Since the processor 11 is not involved in the automatic transition from the OFF mode to the normal mode, the automatic transition from the OFF mode to the normal mode can be realized by a simple configuration and with low power.

According to some embodiments, the image forming apparatus 1 raises Vcc 2 and Vcc 3 based on the supply of the power from Vcc 1 in response to the ON state of the latch switch 1002 in response to the recovery of the AC power supply after the AC power supply is turned off. As a result, the operation mode of the image forming apparatus 1 automatically shifts from the OFF mode to the normal mode through the standby mode without operation by the processor 11 in response to the recovery of the AC power supply after the AC power supply is turned off. Since the processor 11 is not involved in the automatic transition from the OFF mode to the normal mode in response to the recovery of the AC power supply after the AC power supply is turned off, the automatic transition from the OFF mode to the normal mode can be realized by a simple configuration and with low power.

According to the some embodiments, the image forming apparatus 1 switches the operation mode from the normal mode to either the OFF mode or the standby mode based on the startup in response to the recovery of the AC power supply after the AC power supply is turned off. Typically, the image forming apparatus 1 performs control to switch the state of the latch switch 1002 from the OFF state to the ON state and to lower Vcc 3 according to the determination result indicating that the image forming apparatus 1 is connected with the external device based on the startup in response to the recovery of the AC power supply after the AC power supply is turned off. The image forming apparatus 1 performs control to maintain the state of the latch switch 1002 in the OFF state and to lower Vcc 2 and Vcc 3 according to the determination result indicating that the image forming apparatus 1 is not connected with the external device. As a result, the image forming apparatus 1 having the automatic transition function to each operation mode can maintain the original operation mode without the operation by the user after the recovery of the AC power supply even when the AC power supply is turned off due to the power failure or the like. In other words, the image forming apparatus 1 can recover in the standby mode without pressing the power supply key 151 after the AC power supply recovers even if the AC power supply is turned off in the standby state in the standby mode. For example, even if the AC power supply of the image forming apparatus 1 is turned off at night, the image forming apparatus 1 can recover in the standby mode after the recovery of the AC power supply, and thus, the image forming apparatus 1 can receive the facsimile.

According to some embodiments, the image forming apparatus 1 is configured in such a manner that Vcc 2 is higher in the power than Vcc 1 and Vcc 3 is higher in the power than Vcc 2. When the image forming apparatus 1 recovers to the original operation mode after the AC power supply is turned off, the processor 11 supplied with the power from Vcc 3 is temporarily involved. Therefore, the image forming apparatus 1 can realize the recovery to the original operation mode after the AC power supply is turned off with low power consumption.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a power supply key;
a latch switch connected to a signal line of the power supply key and configured to maintain a state of a power supply in response to pressing on the power supply key when the latch switch is in an ON state; and
a processor configured to perform control to set the state of the latch switch to an OFF state in a first mode, the first mode corresponding to a state in which the image forming apparatus is not connected with an external device, and to set the state of the latch switch to the ON state in a second mode, the second mode corresponding to a state in which the image forming apparatus is connected with the external device.

2. The image forming apparatus according to claim 1, further comprising:
a first circuit, connected with a signal line of the latch switch, to which power from a first DC power supply relating to the first mode is supplied in response to the pressing on the power supply key or in response to the ON state of the latch switch, and configured to raise a second DC power supply relating to the second mode based on supply of power from the first DC power supply; and
a second circuit configured to operate based on supply of power from the second DC power supply, and to raise a third DC power supply relating to startup of the processor.

3. The image forming apparatus according to claim 2, wherein
the second DC power supply is higher in power than the first DC power supply, and the third DC power supply is higher in power than the second DC power supply.

4. The image forming apparatus according to claim 2, wherein
the first circuit is configured to raise the second DC power supply based on the supply of power from the first DC power supply according to the ON state of the latch switch in response to recovery of an AC power supply after the AC power supply is turned off,
the second circuit is configured to raise the third DC power supply based on the supply of power from the second DC power supply, and
the processor is started based on supply of power from the third DC power supply.

5. The image forming apparatus according to claim 4, wherein
the processor is configured to switch an operation mode of the processor to either the first mode or the second mode based on startup in response to recovery of the AC power supply after the AC power supply is turned off.

6. The image forming apparatus according to claim 4, wherein
the processor is configured to:
perform control to set the latch switch to the OFF state from the ON state based on startup in response to recovery of the AC power supply after the AC power supply is turned off,
determine whether the image forming apparatus is connected with or not connected with the external device,
perform control to switch the state of the latch switch from the OFF state to the ON state and lower the third DC power supply according to a determination result indicating that the image forming apparatus is connected with the external device, and
perform control to maintain the state of the latch switch in the OFF state and lower the second DC power supply and the third DC power according to a determination result indicating that the image forming apparatus is not connected with the external device.

7. The image forming apparatus according to claim 6, wherein
the second DC power supply is higher in power than the first DC power supply, and the third DC power supply is higher in power than the second DC power supply.

8. A method of operating an image forming apparatus including a power supply key and a latch switch connected to a signal line of the power supply key, the method comprising:
maintaining a state of a power supply in response to pressing on the power supply key when the latch switch is in an ON state;
performing control to set the state of the latch switch to an OFF state in a first mode, the first mode corresponding to a state in which the image forming apparatus is not connected with an external device; and
setting the state of the latch switch to the ON state in a second mode, the second mode corresponding to a state in which the image forming apparatus is connected with the external device.

9. The method according to claim 8, further comprising:
supplying power from a first DC power supply relating to the first mode to a first circuit, connected with a signal line of the latch switch, in response to the pressing on the power supply key or in response to the ON state of the latch switch;
raising a second DC power supply relating to the second mode based on supply of power from the first DC power supply;
operating a second circuit based on supply of power from the second DC power supply; and
raising a third DC power supply relating to startup of a processor performing the control to set the state of the latch switch.

10. The method according to claim 9, wherein
the second DC power supply is higher in power than the first DC power supply, and the third DC power supply is higher in power than the second DC power supply.

11. The method to claim 9, further comprising:
raising the second DC power supply based on the supply of power from the first DC power supply according to the ON state of the latch switch in response to recovery of an AC power supply after the AC power supply is turned off,
raising the third DC power supply based on the supply of power from the second DC power supply, and
starting the processor based on supply of power from the third DC power supply.

12. The method according to claim 11, further comprising:
switching an operation mode of the processor to either the first mode or the second mode based on startup in response to recovery of the AC power supply after the AC power supply is turned off.

13. The method according to claim 11, further comprising:
performing control to set the latch switch to the OFF state from the ON state based on startup in response to recovery of the AC power supply after the AC power supply is turned off,
determining whether the image forming apparatus is connected with or not connected with the external device;
performing control to switch the state of the latch switch from the OFF state to the ON state and lower the third DC power supply according to a determination result indicating that the image forming apparatus is connected with the external device; and
performing control to maintain the state of the latch switch in the OFF state and lower the second DC power supply and the third DC power according to a determination result indicating that the image forming apparatus is not connected with the external device.

14. The method according to claim 13, wherein
the second DC power supply is higher in power than the first DC power supply, and the third DC power supply is higher in power than the second DC power supply.
